(19) United States
(12) Patent Application Publication
(10) Pub. No.: US 2013/0332832 A1
(43) Pub. Date: Dec. 12, 2013

(54) INTERACTIVE MULTIMEDIA SYSTEMS AND METHODS

(71) Applicant: QUANTA COMPUTER INC., Quanta Computer Inc. (TW)

(72) Inventor: Kang-Wen Lin, Kuei Shan Hsiang (TW)

(73) Assignee: QUANTA COMPUTER INC., Kuei Shan Hsiang, Tao Yuan Shien (TW)

(21) Appl. No.: 13/662,918

(22) Filed: Oct. 29, 2012

(30) Foreign Application Priority Data
Jun. 11, 2012 (TW) 101120857

(51) Int. Cl. G06F 3/01

(52) U.S. Cl. 715/719

(57) ABSTRACT

An interactive multimedia system with a display device and a processing module is provided. The display device receives and displays images of a video session between a first user and a second user. The processing module identifies a third user from the images of the video session, and performs interactive operations with the third user during the video session.

### CROSS REFERENCE TO RELATED APPLICATIONS

This Application claims priority of Taiwan Patent Application No. 101120857, filed on Jun. 11, 2012, the entirety of which is incorporated by reference herein.

### BACKGROUND OF THE INVENTION

1. Field of the Invention

The invention generally relates to the design of operating interfaces, and more particularly, to interactive multimedia systems and multimedia interaction methods for providing interactive operations with a third party during an ongoing video session.

2. Description of the Related Art

With rapid developments in ubiquitous computing/networking and smart phones in recent years, real-time multimedia applications, including video calling, video conferencing, video on demand, High-Definition TV programs, and on-line teaching/learning courses, etc., are becoming more and more popular. For enterprises, remote management may be conducted through the real-time multimedia applications, to improve overall operating efficiencies and lower the costs thereof. Also, for individuals, people-to-people communications are a lot easier through the real-time multimedia applications, so as to increase the convenience of everyday life.

Unfortunately, most operation interfaces made for video sessions only allow users to choose specific subject(s) before initiating the video sessions, and lack flexibility for interactive operations with a third party. Take a one-on-one video session as an example. If User A wants to perform interactive operations with User C during an ongoing video session with User B, User A has to stop the ongoing video session with User B and then initiate another video session with User C, or User A has to switch to another operation interface to send messages to User C.

Thus, it is desirable to have a multimedia interaction method for providing interactive operations with a third party during an ongoing video session.

### BRIEF SUMMARY OF THE INVENTION

In one aspect of the invention, an interactive multimedia system comprising a display device and a processing module is provided. The processing module receives and displays images of a video session between a first user and a second user. The processing module identifies a third user from the images of the video session, and performs interactive operations with the third user during the video session.

In another aspect of the invention, a multimedia interaction method is provided. The multimedia interaction method comprises the steps of displaying, on a display device, images of a video session between a first user and a second user, identifying a third user from the images of the video session, and performing interactive operations with the third user during the video session.

Other aspects and features of the invention will become apparent to those with ordinary skill in the art upon review of the following descriptions of specific embodiments of the interactive multimedia systems and multimedia interaction methods.

### BRIEF DESCRIPTION OF DRAWINGS

The invention can be more fully understood by reading the subsequent detailed description and examples with references made to the accompanying drawings, wherein:

FIG. 1 is a block diagram illustrating a interactive multimedia system according to an embodiment of the invention;

FIG. 2 is a block diagram illustrating a multimedia user equipment according to an embodiment of the invention;

FIG. 3 is a block diagram illustrating a multimedia server according to an embodiment of the invention;

FIG. 4 is a schematic diagram illustrating the operations related to the multimedia interaction interfaces on the multimedia user equipments according to an embodiment of the invention;

FIG. 5 is a schematic diagram illustrating the operations related to the multimedia interaction interfaces on the multimedia user equipments according to another embodiment of the invention;

FIG. 6 is a schematic diagram illustrating the operations related to the multimedia interaction interfaces on the multimedia user equipments according to yet another embodiment of the invention;

FIG. 7 is a flow chart illustrating the multimedia interaction method according to an embodiment of the invention; and

FIGS. 8A to 8C show a flow chart of the multimedia interaction method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

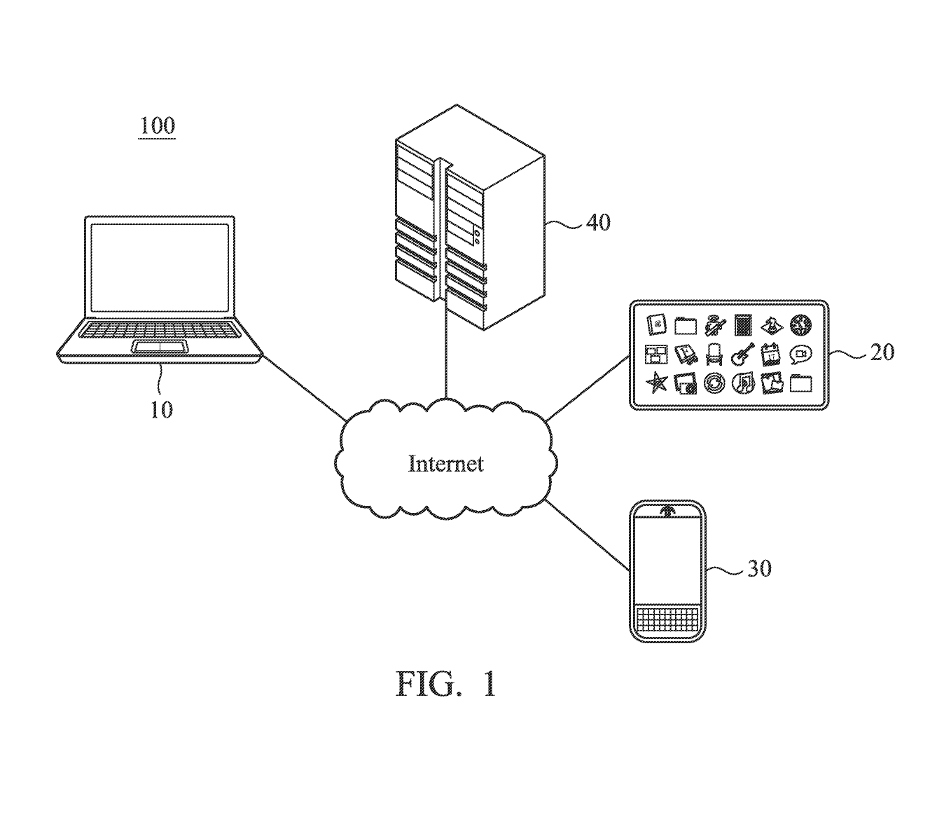

FIG. 1 is a block diagram illustrating an interactive multimedia system according to an embodiment of the invention. In the interactive multimedia system 100, the multimedia user equipments 10, 20, and 30 communicate with each other via the multimedia server 40 for interactions, including initiating video sessions, sending voice or text messages, sending emails, and sharing electronic files, etc. Each of the multimedia user equipments 10, 20, and 30 may be a smart phone, panel Personal Computer (PC), laptop computer, desktop computer, or any multimedia device with networking functionality, so that it may connect to the Internet through wired or wireless communications. The multimedia server 40 may be a computer or workstation on the Internet for providing video streaming and the above services.

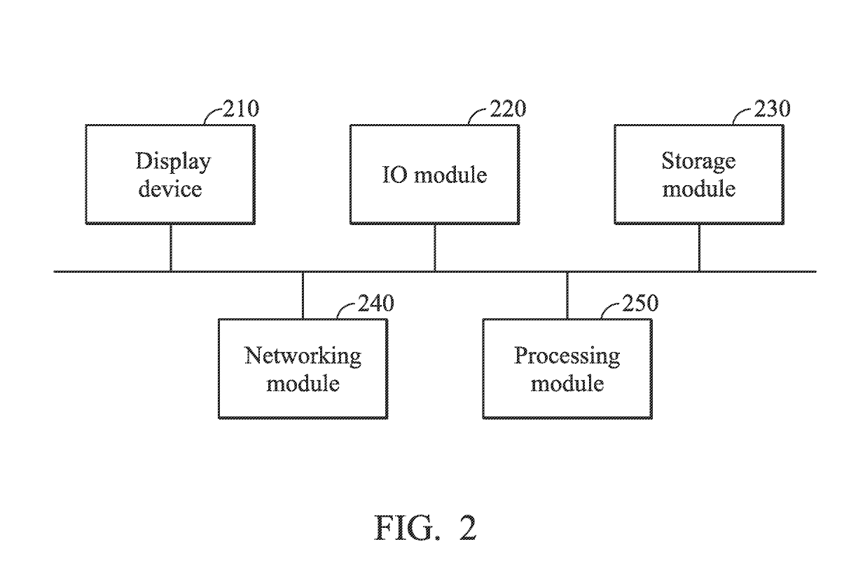

FIG. 2 is a block diagram illustrating a multimedia user equipment according to an embodiment of the invention. The display device 210 may be a screen, panel, touch panel, or any device with displaying functionality. The Input/Output (IO)) module 220 may comprise built-in or external components, such as a video camera, microphone, speaker, keyboard, mouse, and touch pad, etc. The storage module 230 may be a volatile memory, e.g., Random Access Memory (RAM), or non-volatile memory, e.g., FLASH memory, or hardware, compact disc, or any combination of the above media. The networking module 240 is responsible for providing network connections using a wired or wireless technology, such as Ethernet, Wireless Fidelity (WiFi), mobile telecommunications technology or others. The processing module 250 may be a general purpose processor or a Micro Control Unit (MCU) which is responsible for executing machine-readable instructions to control the operations of the display device 210, the IO module 220, the storage module 230, and the networking module 240, and to perform the multimedia interaction method of the invention.

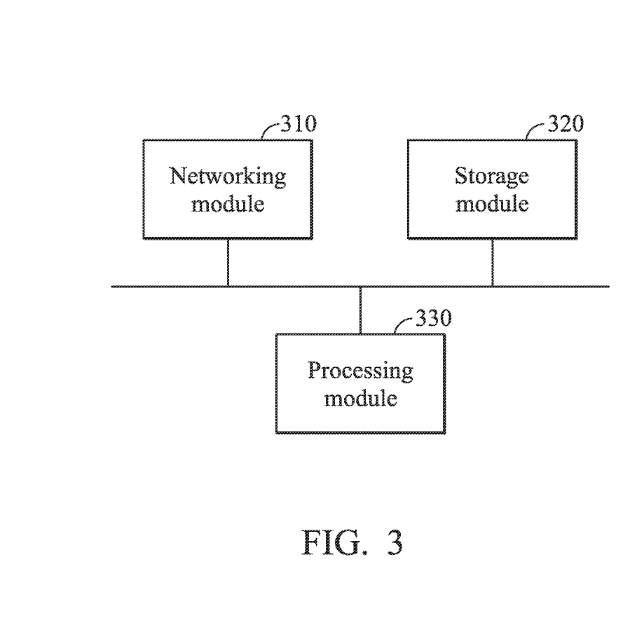

FIG. 3 is a block diagram illustrating a multimedia server according to an embodiment of the invention. The networking module 310 is responsible for providing wired or wireless connections. The storage module 320 is used for storing machine-executable program code and information concerning the multimedia user equipments 10, 20, and 30. The processing module 330 is responsible for loading and executing the program code stored in the storage module 320 to perform the multimedia interaction method of the invention.

Note that, in another embodiment, the multimedia server 40 may be incorporated into each of the multimedia user equipments 10, 20, and 30. That is, each of the multimedia user equipments 10, 20, and 30 is capable of providing video streaming services, so that the video sessions between any two of the multimedia user equipments 10, 20, and 30 may be initiated directly without the coordination by a stand-alone multimedia server. Thus, the invention is not limited to the architecture shown in FIG. 1.

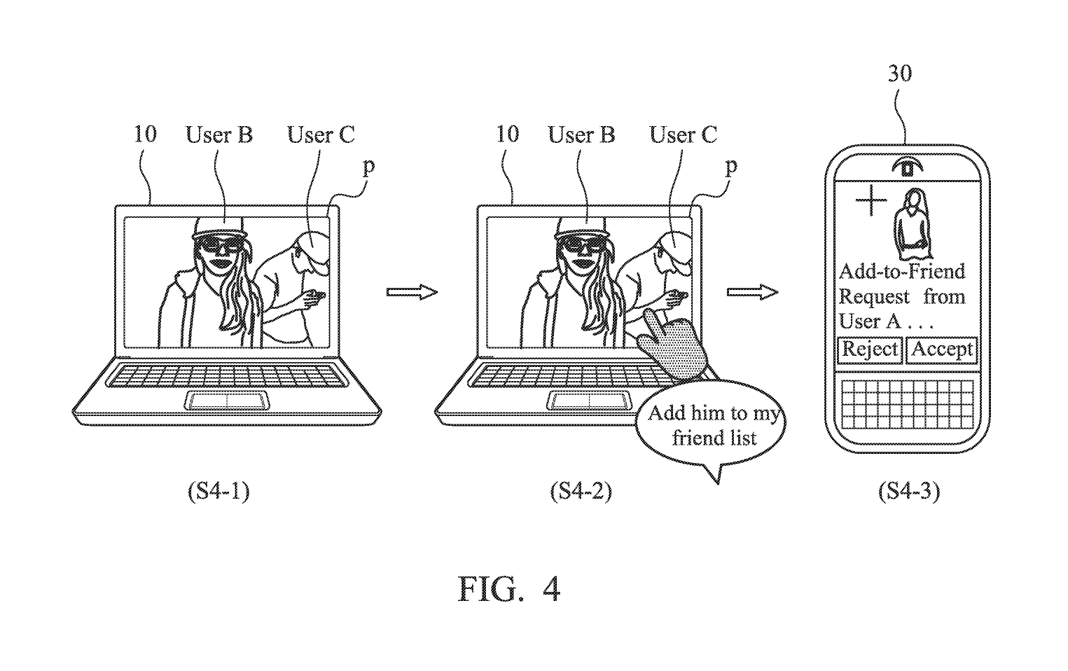

FIG. 4 is a schematic diagram illustrating the operations related to the multimedia interaction interfaces on the multimedia user equipments according to an embodiment of the invention. In this embodiment, the multimedia user equipments 10, 20, and 30 are operated by Users A, B, and C, respectively, and the following description is given mainly based on the operation experience of User A, i.e., based on the operations on the multimedia user equipment 10. To begin, in step S4-1, the multimedia user equipment 10 initiates a video session with the multimedia user equipment 20 via the multimedia server 40, and the image p of the video session at the side of User B is displayed on the display device of the multimedia user equipment 10. Particularly, in addition to User B, User C also appears in the image p of the video session (e.g., Users B and C are ‘hanging out’ when the video session is initiated). When User A sees User C in the image p of the video session, he/she may further generate a command input by a multimodal operation (such as, speech, a touch event, a gesture, a mouse event, or any combination thereof), to interact with User C, without using another Graphic User Interface (GUI) or establishing another video session with User C for further interaction. Specifically, in step S4-2, User A touches the location of User C in the image displayed on the display device of the multimedia user equipment 10, and at the same time, specifies the interaction he/she wants to have with User C by saying: “Adding him to my friend list”. In response to the touch event generated by User A, the multimedia server 40 first identifies User C from the image p of the video session, and then transforms the speech input of User A into an add-to-friend request by Natural Language Processing (NLP) and sends the add-to-friend request to the multimedia user equipment 30. Next, in step S4-3, the add-to-friend request received from User A is displayed on the display device of the multimedia user equipment 30.

In a specific embodiment, in response to the touch event generated by User A, the multimedia server 40 may determine whether User C is already in the friend list of User A. If not, User A may not have to generate the speech input and the multimedia server 40 may proactively send an add-to-friend request to the multimedia user equipment 30.

In a specific embodiment, during the interaction between User A and User C, the video session between User A and User B may be paused, and resumed later when User A generates another command input to end the interaction with User C. For example, the command input may be generated by saying: “Back to video session with User B”, or by touching a position other than the position of User C in the image or touching the image of User B on the display device of the multimedia user equipment 10. Alternatively, the video session between User A and User B may be automatically resumed when the interaction between User A and User C is finished.

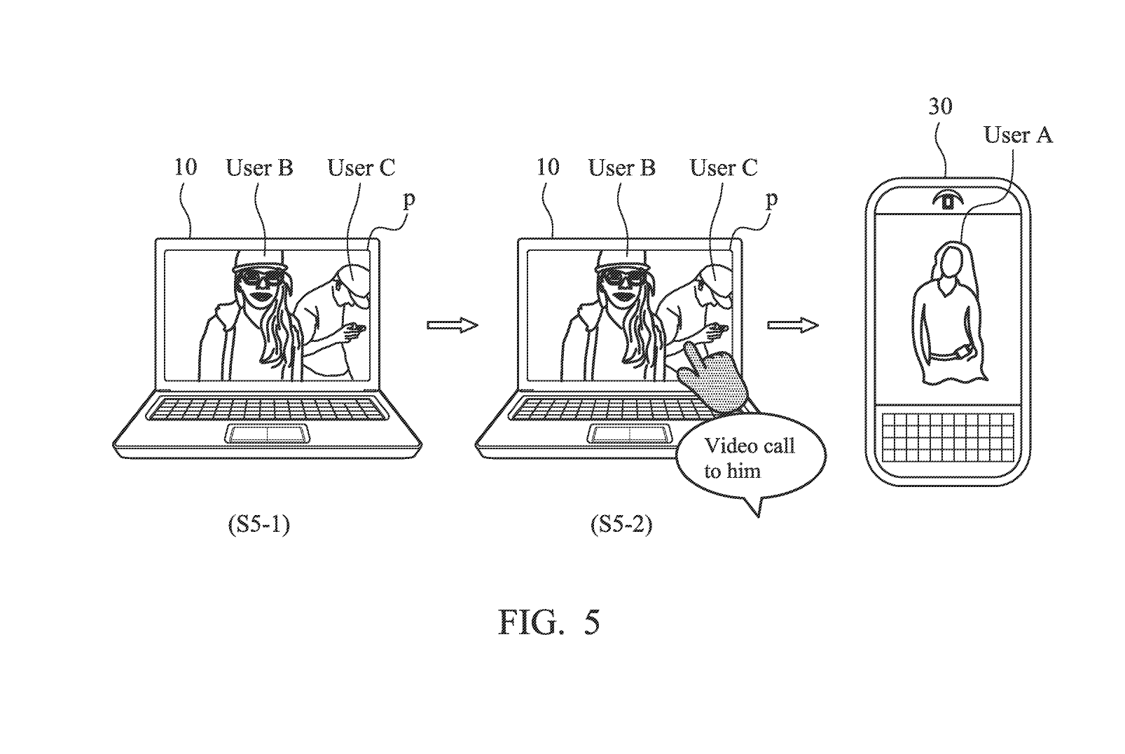

FIG. 5 is a schematic diagram illustrating the operations related to the multimedia interaction interfaces on the multimedia user equipments according to another embodiment of the invention. Similar to FIG. 4, in step S5-2, User A touches the image of User C displayed on the display device of the multimedia user equipment 10, and at the same time, specifies the interaction he/she wants to have with User C by saying: “Video call to him”. Meanwhile, the video session between User A and User B may be paused. In response to the touch event generated by User A, the multimedia server 40 first identifies User C from the image p of the video session, and then transforms the speech input of User A into a video session request by NLP and provides video streaming services for the video session between the multimedia user equipments 10 and 30. Next, in step S5-3, the images of the video session at the side of User A are displayed on the display device of the multimedia user equipment 30. In another embodiment, the video session between User A and User C may be configured to be performed later. For example, in step S5-2, User A may instead generate the command input by saying: “Video call to him after 10 minutes”, and the multimedia server 40 may provide video streaming services for the video session between the multimedia user equipments 10 and 30 after 10 minutes.

In a specific embodiment, in response to the touch event generated by User A, the multimedia server 40 may determine whether User C is already in the friend list of User A. If so, User A may not have to generate the speech input and the multimedia server 40 may proactively send a video session request to the multimedia user equipment 30.

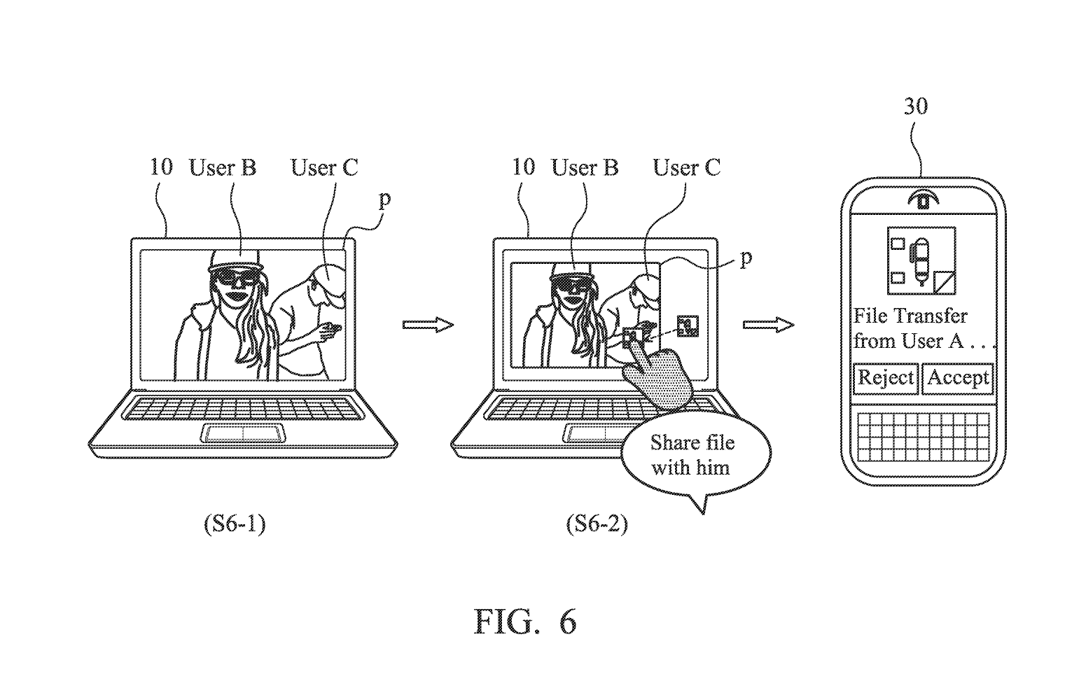

FIG. 6 is a schematic diagram illustrating the operations related to the multimedia interaction interfaces on the multimedia user equipments according to yet another embodiment of the invention. Similar to FIG. 4, in step S6-2, User A drags a file or icon to the image of User C displayed on the display device of the multimedia user equipment 10, and at the same time, specifies the interaction he/she wants to have with User C by saying: “Share file with him”. In response to the touch event generated by User A, the multimedia server 40 first identifies User C from the image p of the video session, and then transforms the speech input of User A into a file sharing request by NLP and sends the file sharing request to the multimedia user equipment 30. Next, in step S6-3, the file sharing request received from User A is displayed on the display device of the multimedia user equipment 30.

In a specific embodiment, when the file icon is dragged to the image of User C displayed on the display device of the multimedia user equipment 10, the multimedia server 40 may proactively generate a file sharing request for the drag event and then send the file sharing request to the multimedia user equipment 30. Meanwhile, User A does not have to specify the interaction he/she wants to have with User C.

In a specific embodiment, the multimedia server 40 may be configured to execute a social networking application in which a public social networking page or website is provided for users to register with, using user information, such as names, phone numbers, email accounts, pictures/images, friend lists, favorite sports, favorite artists, and video clips, etc. Thus, the multimedia server 40 may obtain specific user information, and further link to the public social networking page or website of the user's friends according to the friend list of the user. Consequently, the multimedia server 40 may establish an image database or image features of the user and the user's friends according to the pictures/images of the user and the user's friends. Moreover, the user may provide to the multimedia server 40 with his/her account of other public social networking pages or websites, such as Facebook, Google+, or others, and the multimedia server 40 may collect further information of the user from these social networking pages or websites. In a specific embodiment, the multimedia server 40 may establish a respective image database or image features for each user.

In the embodiments of FIGS. 4 to 6, before the initiation of the video session between User A and User B, the multimedia server 40 may collect the image information according to user A's account(s) of public social networking page/website in advance, and then analyze the features of the image information to establish an image database. After that, in the step of identifying User C from the image p of the video session, the multimedia server 40 may use the face detection technique to extract/obtain the appearance features of User C, and then compare the appearance features of User C with the image information in the image database to identify User C and see if User C is a friend of User A.

In the embodiments of FIGS. 4 to 6, before the initiation of the video session between User A and User B, the multimedia server 40 may collect the friend information of User A, including names, phone numbers, and email accounts, etc., according to user B's social network account(s). Next, User B may add a user tag to User C in the image database. After that, in the step of identifying User C from the image p of the video session, the multimedia server 40 may identify User C and obtain related information according to the user tag added by user B.

Please note that, in addition to the embodiments of FIGS. 4 to 6, the interaction between User A and User C may include: sending a voice or text message, sending an email, and sending a meeting notice, etc, and the invention is not limited thereto.

Regarding the multimodal operation aforementioned, in other embodiments, User A may generate the command input by a predefined gesture, e.g., drawing a circle on the image of User C displayed on the display device of the multimedia user equipment 10 if User A wants to add User C into a block list of the phone book or specific social network(s).

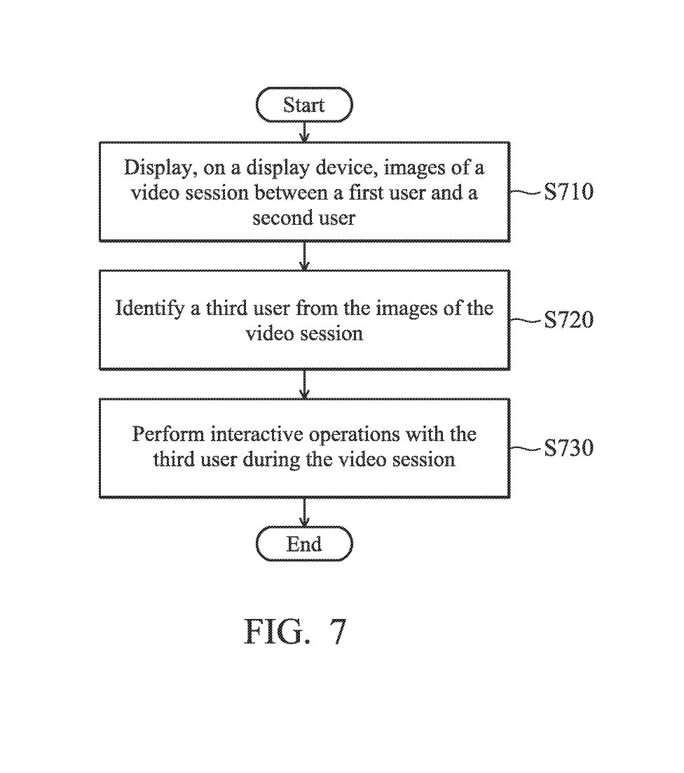

FIG. 7 is a flow chart illustrating the multimedia interaction method according to an embodiment of the invention. In this embodiment, the multimedia interaction method may be applied to the multimedia user equipments 10 to 30 and the multimedia server 40 in coordination, or may be applied to alternative multimedia user equipments which incorporating the functionality of the multimedia server 40. To begin, images of a video session between a first user and a second user is displayed on a display device (step S710), and then a third user is identified from the images of the video session (step S720). Next, interactive operations with the third user are performed during the video session (step S730). The interactive operations may include: adding the third user to a friend list, initiating another video or voice session with the third user, sending a voice or text message to the third user, sending an email to the third user, sending a meeting notice to the third user, and sharing an electronic file with the third user. Specifically, the interactive operations in step S730 may be performed according to a command input generated by a multimodal operation, such as, speech, a touch event, a gesture, a mouse event, or any combination thereof, and the video session between the first user and the second user may not be ended or stopped for the interactive operations.

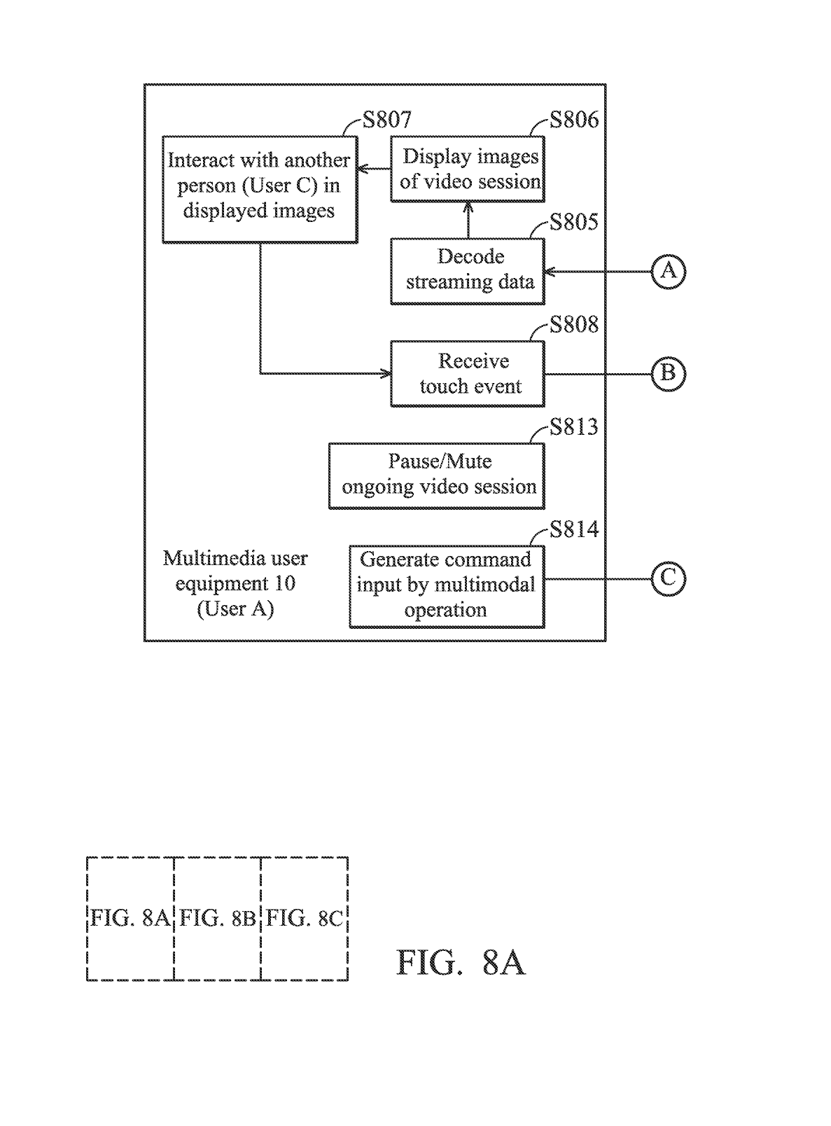

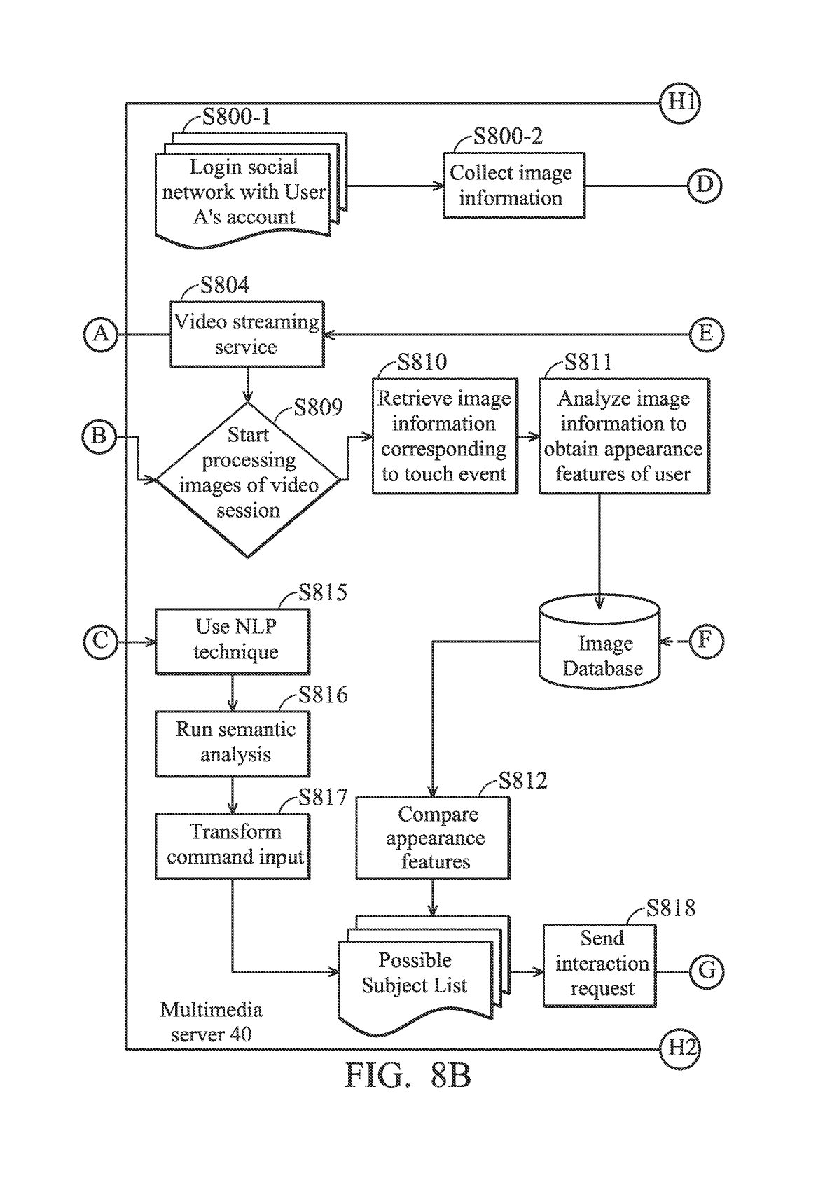

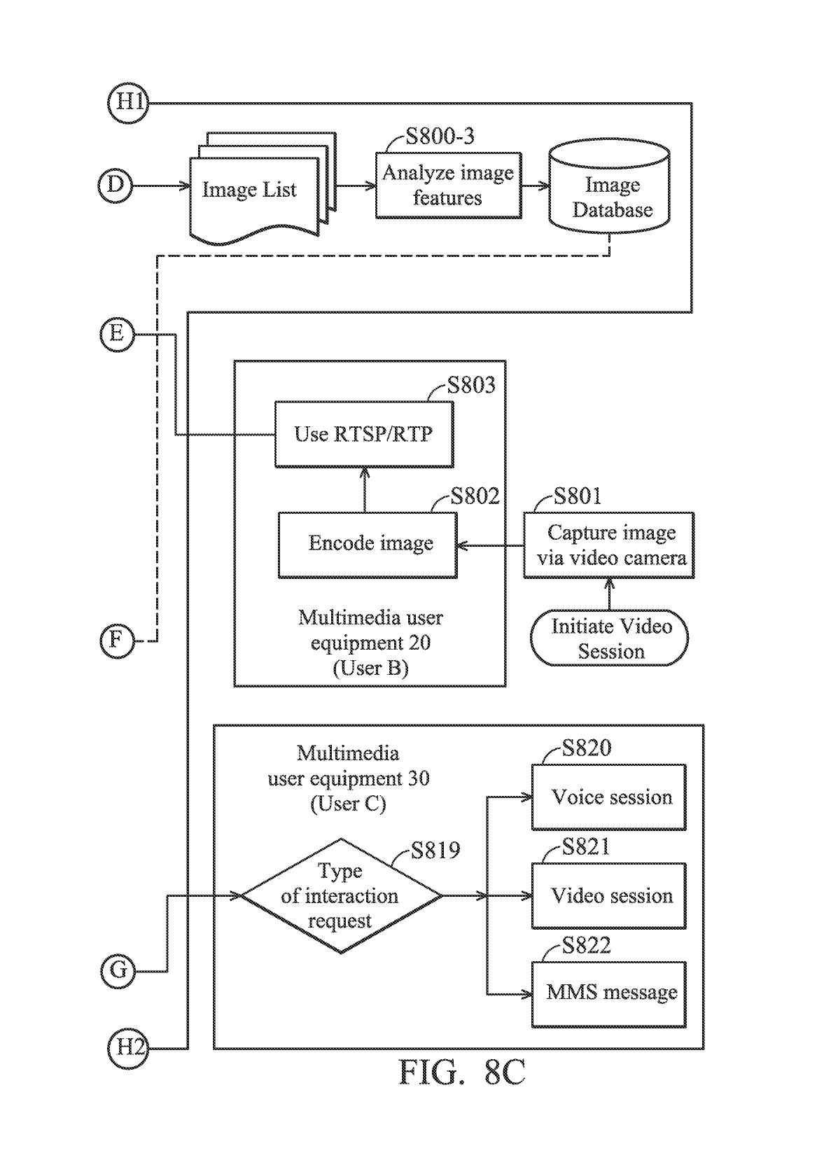

FIGS. 8A to 8C show a flow chart of the multimedia interaction method according to another embodiment of the invention. In this embodiment, the multimedia interaction method may be applied to the multimedia user equipments 10 to 30 and the multimedia server 40 in coordination. To begin, before the initiation of the video session between User A and User B, the multimedia server 40 collects the image information of User A using User A's account of a public social networking page or website in advance (steps S800-1˜S800-2), and then analyzes the features of the image information to establish an image database (step S800-3). In addition to the image information, the multimedia server 40 may collect other information of User A, such as the friend list of User A, in advance. When User B initiates the video session with User A, the multimedia user equipment 20 captures the image of User B via a video camera (step S801), and encodes the captured image (step S802). Next, the multimedia user equipment 20 transmits the encoded image to the multimedia server 40 using the Real Time Streaming Protocol (RTSP) or Real-time Transport Protocol (RTP) (step S803), so that the multimedia server 40 establishes the video session between User A and User B (step S804). The multimedia user equipment 10 decodes the received streaming data (step S805), and then displays the image of User B on a display device (step S806). Although not shown, the image of User A may be streamed to the multimedia user equipment 20 via the multimedia server 40 for user B's viewing demand, with similar steps as S801˜S806.

As User A recognizes that not only User B but also User C are in the images of the video session (or likewise, as User B recognizes that not only User A but also User C is in the images of the video session), he/she decides to interact with User C as well (step S807). Subsequently, User A touches the image of User C displayed on the display device of the multimedia user equipment 10 (step S808). In response to the touch event, the multimedia server 40 starts processing the images of the video session (step S809), and retrieves the image information corresponding to the touch event, i.e., the image information of User C (step S810). Also, the multimedia server 40 continues with analyzing image information to obtain the appearance features of User C (step S811), and comparing the appearance features of User C with the established image database (step S812). Accordingly, the multimedia server 40 may determine that User C is the user in which User A wants to interact with and also determine the related information of User C.

After the touch event triggered by User A, the ongoing video session between User A and User B may be paused or muted (step S813), and User A may generate a command input by a multimodal operation (step S814). Note that, in other embodiments, the video session between User A and User B may not be paused/muted, and may be continued instead. After that, the multimedia server 40 uses the NLP technique to process the command input (step S815), and then runs semantic analysis on the processing result (step S816), thereby transforming the command input into machine-readable instruction(s) (step S817). With the machine-readable instruction(s) and the determined subject, the multimedia server 40 further sends an interaction request to the multimedia user equipment 30 (step S818).

At the side of User C, the multimedia user equipment 30 first determines the type of the interaction request for subsequent operations (step S819). Specifically, if the interaction request is for initiating a voice session, the multimedia user equipment 30 establishes the voice session with User A (step S820). If the interaction request is for initiating a video session, the multimedia user equipment 30 establishes a video session with User A (step S821). If the interaction request is for delivering a Multimedia Messaging Service (MMS) message, the multimedia user equipment 30 receives the MMS message from User A (step S822). The MMS message may contain a text message, add-to-friend request, and/or file transfer, etc.

In a specific embodiment, step S814 may be omitted and replaced with generating a predetermined command input according to related information of User A. For example, if the multimedia server 40 determines that User C is not a friend of User A, the predetermined command input may be an add-to-friend request and step S814 may be omitted. Otherwise, if the multimedia server 40 determines that User C is a friend of User A, the predetermined command input may be a voice call attempt and step S814 may be omitted. Step S814 may be performed only when User A wants to initiate a video session or send an MMS message, so that the multimedia server 40 may know subsequent operations according to the generated command input.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

1. An interactive multimedia system, comprising:
a display device, receiving and displaying images of a video session between a first user and a second user; and
a processing module, analyzing image information associated with a respective social networking page or website of each of the first user, the second user, and the third user, to establish an image database, identifying a third user from the images of the video session, by obtaining appearance features of the third user from the images of the video session, and comparing the appearance features of the third user with the image database, and performing interactive operations with the third user during the video session.

2-3. (canceled)

4. The interactive multimedia system of claim 1, wherein the interactive operations comprise at least one of the following:
adding the third user to a friend list;
initiating another video or voice session with the third user;
sending a voice or text message to the third user;
sending an email to the third user;
sending a meeting notice to the third user; and
sharing an electronic file with the third user.

5. The interactive multimedia system of claim 1, wherein the interactive operations are performed according to a command input generated by at least one of the following:
speech;
a touch event;
a gesture; and
a mouse event.

6. A multimedia interaction method, comprising:
displaying, on a display device, images of a video session between a first user and a second user;
analyzing image information associated with a respective social networking page or website of each of the first user, the second user, and the third user, to establish an image database;
identifying a third user from the images of the video session, by obtaining appearance features of the third user from the images of the video session and comparing the appearance features of the third user with the image database; and
performing interactive operations with the third user during the video session.

7-8. (canceled)

9. The multimedia interaction method of claim 6, wherein the interactive operations comprise at least one of the following:
adding the third user to a friend list;
initiating another video or voice session with the third user;
sending a voice or text message to the third user;
sending an email to the third user;
sending a meeting notice to the third user; and
sharing an electronic file with the third user.

10. The multimedia interaction method of claim 6, wherein the interactive operations are performed according to a command input generated by at least one of the following:
speech;
a touch event;
a gesture; and
a mouse event.

11. The interactive multimedia system of claim 1, wherein the processing module further receives a user tag for the third user, which is added by one of the first user and the second user, and stores the user tag in the image database, and wherein the third user is identified according to the user tag in the image database.

12. The multimedia interaction method of claim 6, further comprises:
receiving a user tag for the third user, which is added by one of the first user and the second user; and
storing the user tag in the image database,
wherein the third user is identified according to the user tag in the image database.
